(19) United States
(12) Patent Application Publication
(10) Pub. No.: US 2004/0030768 A1
(43) Pub. Date: Feb. 12, 2004

(54) Unified system and method for downloading code to heterogeneous devices in distributed storage area networks

(76) Inventors: Suban Krishnamoorthy, Shrewsbury, MA (US); John R. Graham, Hudson, MA (US)

Correspondence Address: HEWLETT-PACKARD COMPANY, Intellectual Property Administration, P.O. Box 272400, Fort Collins, CO, 80527-2400, US

(21) Appl. No.: 10/446,262

(22) Filed: May 23, 2003

Related U.S. Application Data
(63) Continuation-in-part of application No. 09/318,692, filed on May 25, 1999.

(51) Int. Cl. G06F 15/173; G06F 15/16

(52) U.S. Cl. 709/223

(57) ABSTRACT

A system and method for downloading software to a plurality of devices in a storage network. A command processor receives commands from an external source to download a software module to a plurality of devices matching a predefined set of criteria. A device selector module receives a command from the command processor and selects devices that satisfy the criteria in the command. A coordinator module coordinates code load for the software module to be downloaded, and a multivendor device download module initiates a software download to a plurality of devices in the network after authentication. The system may implement multiple techniques to discover various devices in a Storage Area Network (SAN), and may perform path and load-based distributed parallel schedulable code load to heterogeneous devices in the storage area network using a unified vendor device independent code load interface. The code load process may utilize host agents that are constructed using a layered architecture.

### RELATED APPLICATIONS

This application is a continuation-in-part and claims the benefit of patent application Ser. No. 09/318,692, filed May 25, 1999, entitled SYSTEM AND METHOD FOR SECURELY DOWNLOADING FIRMWARE TO STORAGE DEVICES AND MANAGING STORAGE DEVICES IN A CLIENT-SERVER ARCHITECTURE, the contents of which are hereby incorporated by reference.

### BACKGROUND

1. Field

This invention relates in general to computing systems devices in the Storage Area Networks (SANs). More particularly, this invention relates to systems and methods for updating software and/or firmware in a plurality of devices in Storage Area Networks.

2. Background

Storage Area Networks (SANs) are an emerging storage technology. Large, multinational organizations are deploying SANs that may comprise hundreds or even thousands of devices, such as switches, hubs, bridges, routers, storage arrays, JBODs, (Just a Bunch of Disks), tape libraries, NAS (Network Attached Storage), Direct Attached Storage devices (DAS), hosts, and management stations. Each storage array within a SAN may, in turn, comprise tens of disks, depending on the size of the storage array.

Multiple communication protocols may be used to communicate between devices in a SAN, or between SANs. Exemplary protocols include fibre channel (FC), iSCSI, FCIP, and infiniband. Devices within a SAN may be internetworked using routers, or other communication devices. Multiple, distributed SANs may be connected with client systems through the Internet and/or through other networks, e.g., Local Area Networks (LANs), or Wide Area Networks (WANs).

SANs may be assembled using devices purchased from various vendors, and hence SANs may include heterogeneous devices. Vendors may release new versions of software (e.g., firmware, management software, and/or application software) on a regular basis, and release schedules may differ widely between various vendors. Therefore, different devices in a SAN may include different versions of software. In addition, vendors may use different methods to load software to different devices.

These and other factors conspire to make the process of updating SAN software, potentially to thousands of heterogeneous devices in a large distributed SAN, a complex, tedious, and time consuming process. It can take weeks or even months for an organization to download new software to devices in SAN(s), depending on the size and number of SANs that an organization has to manage. In addition, maintaining an inventory of the software and/or firmware installed on devices in a SAN(s) can be extremely difficult.

Further, software loading should be performed from a computer system that has a path to the desired devices, and only certain management stations and/or hosts may have a path to certain devices in the network. By contrast, in some instances there may be multiple paths to a single device.

Existing SAN management software tools do not provide a comprehensive solution to the technical problem of downloading software and/or firmware in a SAN. Instead, network administrators perform software download tasks manually using different device-specific tools, typically supplied by the vendor(s) from which the particular device(s) were purchased.

Accordingly, there remains a need in the art for systems and methods for downloading software to a plurality of devices in a storage network.

### BRIEF DESCRIPTION OF THE DRAWINGS

For a better understanding of aspects of the present invention, and to understand how the same may be brought into effect, reference will now be made, by way of one example only, to the accompanying drawings, in which:

FIG. 1 is a block diagram of an exemplary device management system in a client-server architecture;

FIG. 2 is a block diagram of an exemplary device management architecture of a client side;

FIG. 3 is a block diagram of an exemplary server side architecture;

FIG. 4 is a block diagram of layers of an agent shown in FIG. 3;

FIG. 5 is a data structure for an exemplary peripheral master configuration header;

FIG. 6 is a schematic illustration of an exemplary data structure of a command array processor data of group 0 for end of command markers;

FIG. 7 is a schematic illustration of an exemplary data structure of command array processor data of group 1 for SCSI commands;

FIG. 8 is a schematic illustration of an exemplary data structure of command array processor data of group 2 for custom commands and handling descriptors;

FIG. 9 is a schematic illustration of an exemplary data structure of command array processor data of group 3 for screen commands;

FIG. 10 is a flow diagram illustrating an exemplary method for downloading firmware using the data structure for a peripheral master configuration header

FIG. 11 is a schematic illustration of an exemplary data structure for a peripheral simple configuration header;

FIG. 12 is a schematic depiction of an exemplary storage system

FIG. 13 is a schematic depiction of an exemplary architecture for a host agent software module; and

FIG. 14 is a high-level block diagram illustrating components of a multivendor device software download system;

FIG. 15 is a block diagram illustrating with greater detail components of a multivendor device software download system; and

FIG. 16 is a flowchart illustrating an exemplary method for code download; and

FIG. 17 is a flowchart illustrating an exemplary method for computing paths in a SAN.

### DETAILED DESCRIPTION

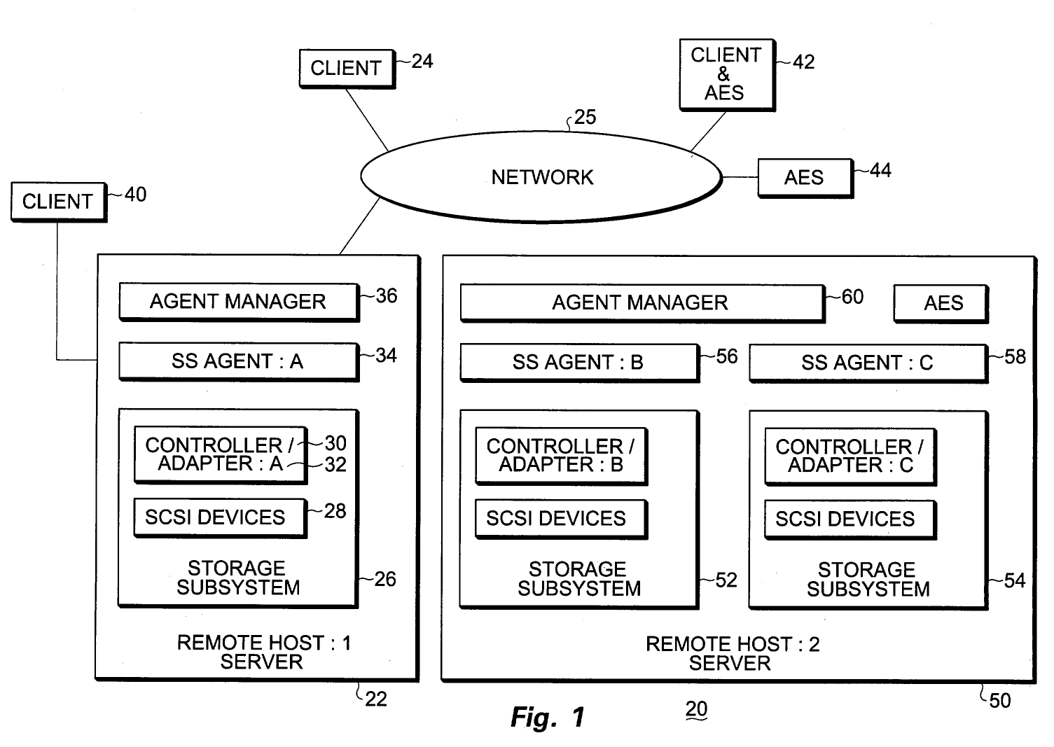

As will be discussed below, system 20 of FIG. 1, which is based on the client-server architecture, permits simultaneous and secure downloading of firmware to storage devices specified by a user. The architecture supports multiple interfaces, multiple command sets, multiple protocols, and multiple hosts with multiple storage subsystems.

System 20 may provide asynchronous event notification services (AES) using distributed AES servers. An AES server is capable of running on a client station 42, on an independent system 44 in the network, or on a server system 50 as shown in FIG. 1.

The TCP/IP protocol may be used to communicate between the server and the client over the network, although it is possible to use other network protocols. Where there is no network, the client is capable of communicating with the adapter or controller coupled to the storage devices using either a SCSI interface or serial port, as shown in FIG. 1 by client 40 coupled to server 22.

As shown in FIG. 1, system 20 includes a server component 22 and a client component 24 communicating over a network 25. Server component 22 may include a storage subsystem 26 having, for example, a plurality or array of SCSI devices 28 coupled to an adapter 32 or controller 30, and the controller, in certain configuration, interfacing directly or through an adapter 32 coupled to the server host. A system 50 can have one or more storage subsystems, as shown in FIG. 1 as 52 and 54.

Server component 22 may include an agent 34 operating on the server, and an optional agent manager 36. Each storage subsystem may include an agent 56, 58 that is responsible for controlling and configuring the storage subsystem. Each agent 56, 58 communicates with the storage devices of the subsystem through the controller/adapter. In an exemplary embodiment server 50 has agent 56 controlling storage subsystem 52 and agent 58 controlling storage subsystem 54.

An agent manager manages agents, as will be described below. One of the functions of an agent manager is security, that is, to ensure that only authorized users can access and manage the storage subsystems to perform administrative operations. In one example, agent manager 60 manages agents 56 and 58 and provides a secure interface from any client applet wishing to communicate with agents 56 or 58. Depending on the particular implementation, where there is no agent manager, the functions and operations performed by the agent manager may be incorporated in and performed by the agents.

Client component 24 may execute on a computing system that is designated as the management station. It may include an applet manager and one or more applets, wherein each applet is adapted to interact with an agent to manage the storage devices in the subsystem. The applet manager manages all of the applets including launching the applets, and passing appropriate information to the applets. The applet manager and the applets provide a user interface to manage the storage devices in the subsystems. Generally, client component 24 supports multiple user interfaces such as GUIs (Graphical User Interfaces), and command interfaces.

Client component 24 may also support different types of controllers and adapters by having different command sets to manage the storage devices coupled thereto. Different applets may use different command sets to communicate with the corresponding agent based on the type of controller used. It is understood that the type of controller or adapter used is a matter of choice.

Storage specific features are contained within the pair of applet and agent corresponding to a storage subsystem. The architecture is modular and permits dynamic addition and deletion of applets and agents as subsystems are added and deleted. Thus, management functions can be dynamically added or removed in accordance with the dynamic changes to the storage subsystems.

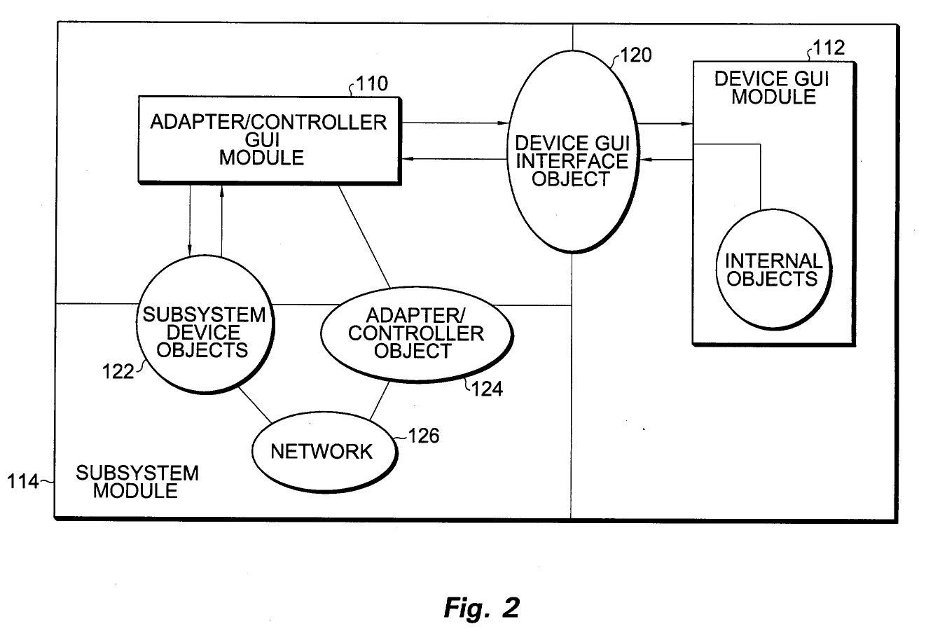

In an exemplary embodiment, various components of the device management architecture may be implemented as modules, and each module may include objects in an object-oriented model. As shown in FIG. 2, each applet may include three different modules, an adapter/Controller GUI module 110, a device GUI module 112, and a storage subsystem module 114.

Adapter/controller GUI module 110 displays a list of storage devices and their statuses, coordinates the download of firmware using other modules, and services traps. To ensure that the device management functions and the code is usable across multiple adapters and controllers, the GUI functions related to device management may be kept separately in a device GUI module 112. For example, device GUI module 112 displays properties and settings for a selected device, and initiates the process for downloading firmware with proper security verification.

Subsystem module 114 reflects the network connection, the adapter/controller, and various storage devices at the agent in the form of objects. Subsystem module 114, in addition to creating objects representing devices, adapter/controller, and network, is capable of building and transmitting commands to the agent and receiving responses for them from the agent. It can do so at the request of other modules in the applet or on its own depending in the condition of the applet.

The applet may include several objects that provide methods for performing various functions. FIG. 2 shows a device GUI interface object 120, subsystem device objects 122, an adapter/controller object 124, and a network object 126. The adapter/controller GUI module 110 communicates with the device GUI module 112 through the device GUI interface object 120 API, and communicates with the subsystem module 114 using the methods of the subsystem device objects 122 and the adapter/controller object 124. Certain member functions of some of the subsystem device objects 122 and the adapter/controller object 124 that need to communicate to the agent do so using the network object 126.

Using a class hierarchy, various objects may be instantiated from their classes. In an exemplary embodiment, there are three classes: (1) a device base class, (2) a device subsystem class, and (3) a device GUI interface class. The device subsystem class may be derived from the device base class. The implementation of some of the device subsystem class member functions may be different between adapters and between controllers depending on how the adapters/controllers communicate with the agent. It is also possible that the device member functions could have different private data members.

With regard to the functionality of the objects, the member functions in the base class, in an exemplary embodiment, do not communicate with the agent. Since the commands and formats used to communicate with the agent differ between controllers and hence their implementation will be different between controllers, member functions that need to communicate with the agent may be specified as virtual in the base class. The virtual functions in the device base class should be implemented in the classes derived from the base class. Their implementation may differ depending on the controllers and adapters used.

The information in the device classes include data such as device name, global ID, capacity, state, vendor ID, product ID, revision, vendor specific information, serial number, mode pages, and channel.

In operation, there may be one object for each adapter/controller in the applet. For each device connected to the adapter/controller, there may be a device object. When a user wants to see the properties of a device or wants to download firmware to a device, the applet creates a device GUI interface object and associates it with the corresponding device object, and activates the device GUI module passing appropriate information through the device GUI interface object. When the user exits the device GUI, the device GUI interface object goes out of scope.

In one embodiment, the applet comprises several layers for interfacing and passing data. At the top layer, the applet interfaces with the applet manager and the user. At the bottom layer, the applet is capable of supporting multiple protocols including TCP/IP. In the middle layers, there is a subsystem object layer and command layer. The subsystem object layer interfaces with and maintains the managed storage objects such as devices, adapters, etc. The command layer contains commands which depend upon the controller or adapter types supported by the applet.

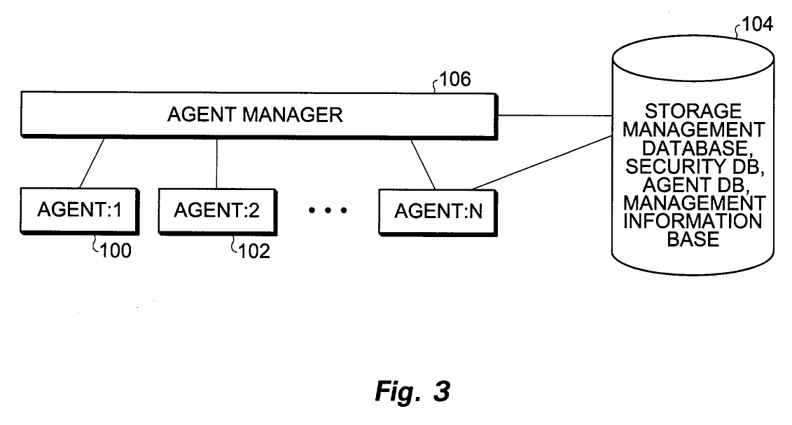

FIG. 3 illustrates a block diagram of an exemplary server side architecture. Depending on the number of storage subsystems in a host computing system, there could be zero or more agents running at the server host. As shown in FIG. 3, the server component comprises an agent manager 106 responsible for all the agents 100, 102 running at the server host. The agent manager manages the agents running on the host.

A storage management database 104 may maintain data relating to security and other data relating to the agents and storage subsystems. It is possible to keep the database 104 either in memory or on persistent storage.

In an exemplary embodiment, agent registration, and agent un-registration features are provided for the agent manager 106 to track currently running agents 100, 102. When an agent 100, 102 starts, it registers with the agent manager 106. As part of the registration, the agent 100, 102 passes information that uniquely identifies the agent 100, 102, subsystem, and, information necessary for a client to establish a connection to the agent 100, 102. When the agent 100, 102 shuts down or is brought down by the user, it notifies the agent manager 106 to un-register it. Upon receiving the request to un-register the agent 100, 102, the agent manager 106 may remove the agent information from a list of agents being managed.

The Agent registration and un-registration feature permits the architecture to be scalable by dynamically providing management support to. newly added subsystems and removing support to subsystems that are removed from the host.

In one example, agent manager 106 uses a known port to service requests from clients. Agents 100, 102 do not use well-known ports to communicate with clients. Addresses of agents 100, 102 may be obtained through agent manager 106. Accordingly, clients need to know only one port, which is the well-known port of agent manager 106, and there are savings of well-known ports, which are limited. There is no need to make the ports of all agents 106 as well-known ports.

In an exemplary embodiment, a protocol for connecting a client to an agent 100, 102 is provided. Any client (i.e., applet) wanting to establish a connection to an agent (e.g. 100, 102) may contact agent manager 106 first with proper agent identification and client authentication. Agent manager 106, by using authentication data in a security database 104, authenticates the client to ensure that it is a valid client. If the client is authorized to communicate with the agent 100, 102 and if the requested agent 100, 102 is running, then agent manager 106 passes the connection information of the agent to the client. If the client is not authorized to communicate with an agent 100, 102, or if the requested agent is not running, then agent manager 106 may deny the connection request. Thus, agent manager 106 provides access security to its registered agents 100, 102. The client establishes a connection to an agent 100, 102 using the information received from the agent manager 106. After establishing connection to the agent, the applet directly communicates with an agent 100, 102 without involving agent manager 106.

After registering with agent manager 106, it is possible that an agent may fail or terminate without un-registering with agent manager 106. To improve reliability, optionally, agent manager 106 can periodically ping or poll the agents 100, 102 for their current status to ensure that the registered agents 100, 102 are running properly and have not terminated. If an agent 100, 102 does not respond to the pings for a certain number of times, then agent manager 106 un-registers the agent 100, 102 and changes its status to not available.

Storage management information may be maintained in database(s) 104 as shown in FIG. 3. Databases 104 may be kept in memory or on persistent storage as needed. Information that is not appropriate to be kept in the database may be obtained in real-time from the subsystem and passed to the client. Both the agent manager 106 and agents 100, 102 can access the appropriate part of the database(s) 104 and extract necessary information, as needed. Access to the database 104 can be centralized or distributed.

Normally, an applet communicates with an agent 100, 102 to get information about a storage subsystem, part or all of which could be in the database 104 or may have to be obtained in real-time from the subsystem. The agent 100, 102 will get the information from the appropriate place(s) and pass it to the applet. The concept of applet-agent communicating with each other in managing storage subsystems makes the architecture modular. Additionally, it allows different protocol layers and interfaces to be used between different applets and the corresponding agents.

Alternatively, a client can pass a request to agent manager 106 for information kept in database 104. The advantage of obtaining data through an agent manager 106 is that a single point of contact is provided to the clients, as opposed to every client having necessary protocol stack for interfacing with the agents 100, 102. Also, information about various subsystems can be maintained in a uniform way. Agent manager 106 can further provide necessary security mechanism in accessing the information from a single point, as described above. On the other hand, a disadvantage of centralized access is that agent manager 106 may become a bottleneck; also for information that is required to be obtained in real-time, agent manager 106 has to request the agent to get it from the subsystem and store it in the database. If the organization of information about various subsystems differs between agents 100, 102, then agent manager 106 has to know how to access several databases.

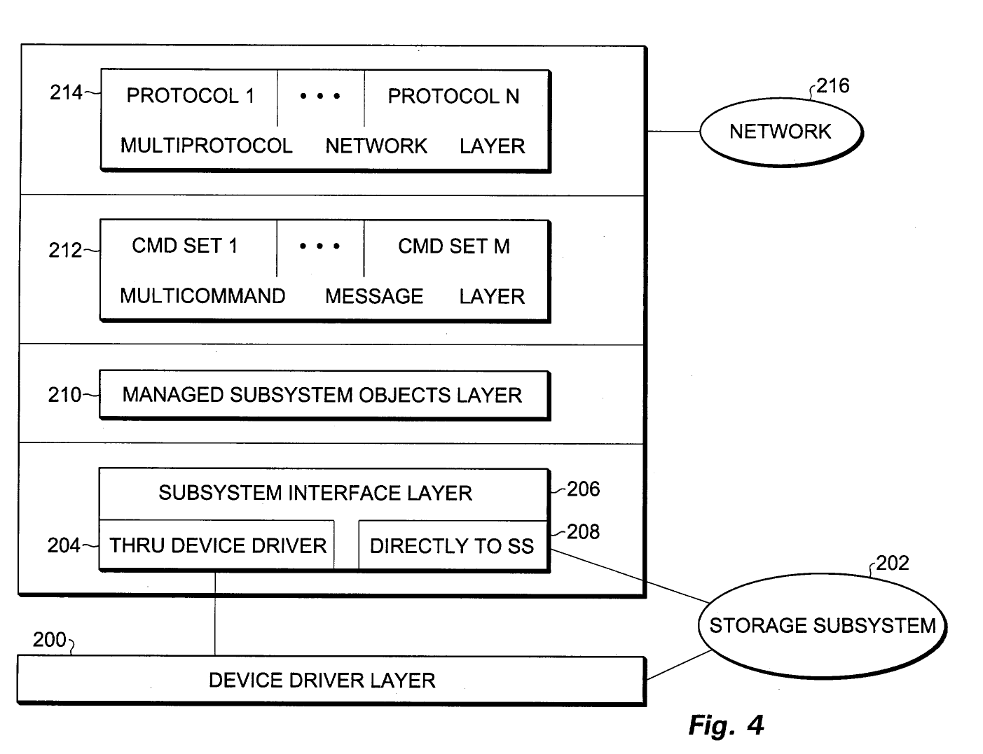

FIG. 4 illustrates a block diagram of the layers of an agent 100, 102, in accordance with an exemplary embodiment. A subsystem interface layer 206 communicates with a storage subsystem 202, either directly using sub-layer 208 or through the device driver 200 using sub-layer 204. A managed subsystem object layer 210 includes various objects that represent the subsystem managed by an agent. Managed subsystem objects layer 210 communicates with a device interface layer 206 to obtain information to populate the objects. It is the counterpart of the applet subsystem managed object layer. The managed subsystem layer uses the command layer 212 to receive various commands from the applet and send responses back to the applet. Different subsystems may use different command sets with varying command structures. Command layer 212 is capable of supporting multiple command sets according to the subsystems. Command layer 212 in turn uses the network layer 214 to communicate with the applet. Network layer 214 is capable of supporting multiple protocols.

Accordingly, with the use of the device management system shown and described, various features, operations, and functions can be performed to manage and configure the storage devices over a network.

### FIRMWARE DOWNLOAD

Downloading firmware in a secure manner to the devices in one or more subsystems and one or more hosts is an exemplary function of storage subsystem device management. The firmware download operation, also referred herein as “codeload”, may be a secure operation since failure or mismanagement can result in permanent device failure and loss of data on the device.

The device management system shown in FIG. 1 can be used for downloading firmware to one or more storage devices. The firmware to be downloaded to the storage devices resides, in one example, at a client management station. The firmware file, herein known as the ASCII Codeload Image File (ACIF) includes a firmware image, and a data header. As used herein, the term firmware image means a copy of the firmware of the storage device. The firmware download process may be accomplished in two phases. In the first phase, the firmware file may be transferred from an applet to an agent. In the second phase, the agent may be instructed by the applet to load the firmware, (i.e., the firmware image), to the storage device.

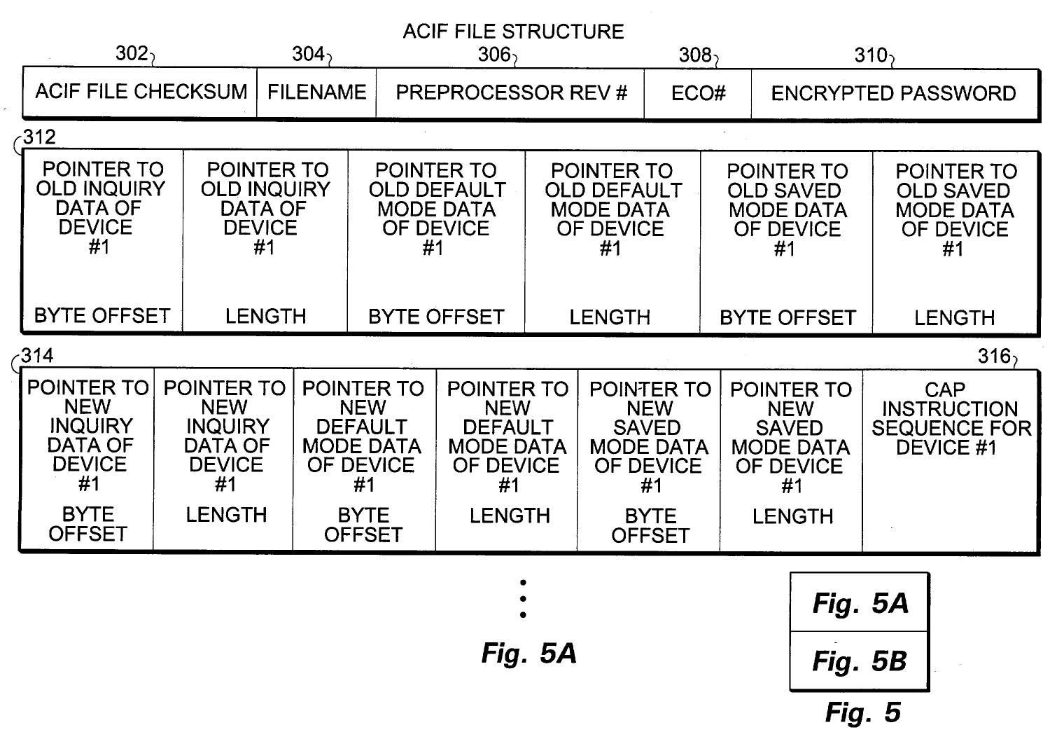

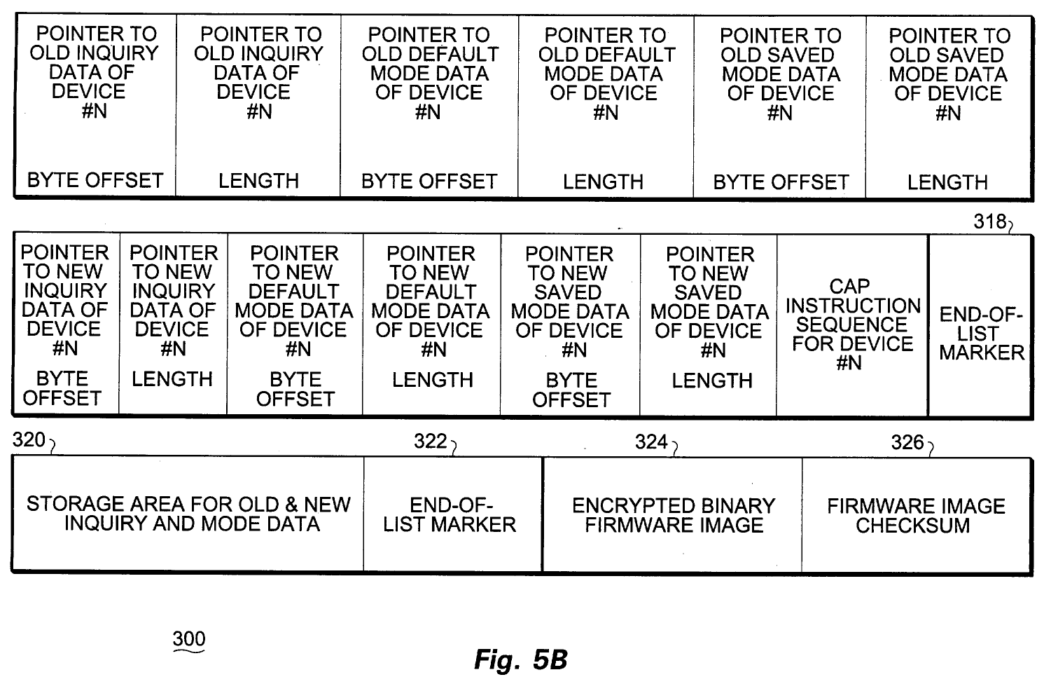

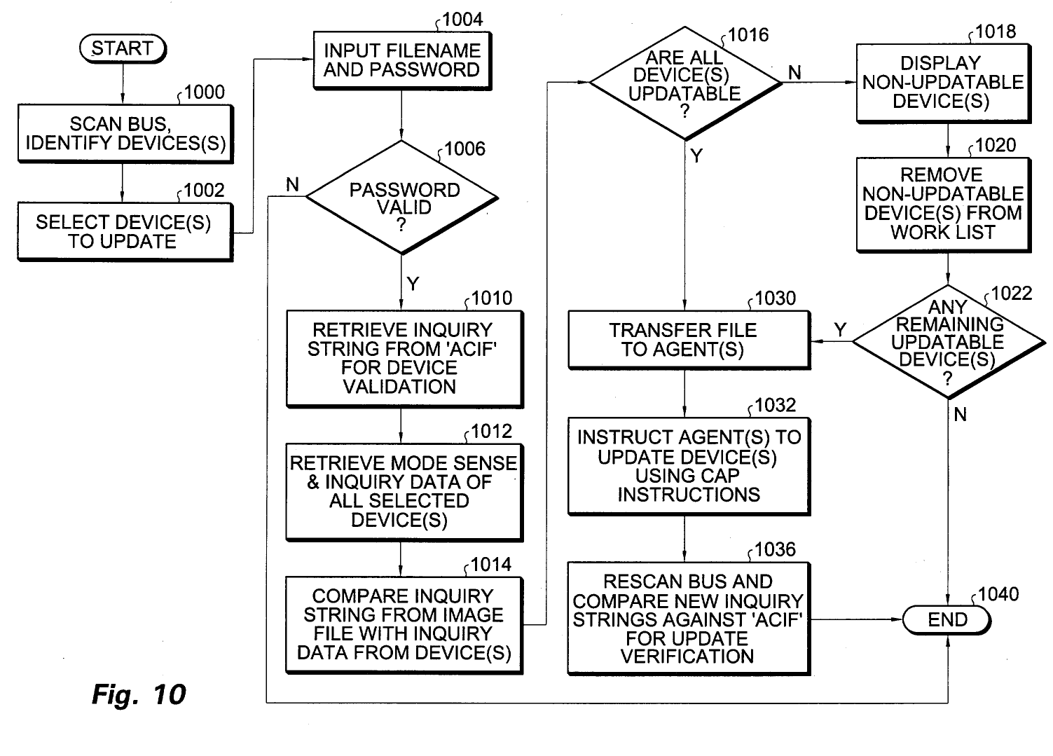

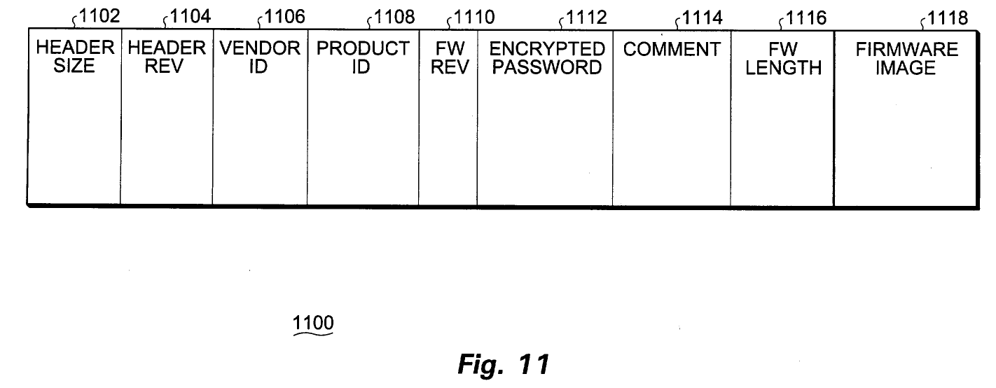

In one example, each firmware image may be preprocessed and a new firmware file may be created with header information added to or embedded to the original image. The header provides information about the firmware and permits version checking, which reduces the chance of inadvertently downloading a wrong firmware version to a device. Two forms of data structures containing the header information and the firmware image are shown in FIGS. 5 and 11. The header format disclosed herein is capable of supporting several devices with specific characteristics.

FIG. 5 illustrates an exemplary data structure 300 for the ASCII Codeload Image File (ACIF). The ACIF may be divided into two discrete elements: a Peripheral Master Configuration Header (PMCH), and the firmware image used by the device(s). The ACIF structure allows for support of multiple device types that utilize the same firmware image. The PMCH, as part of the ACIF structure, includes various data fields relative to the device update process that define the supported device(s) and their configuration settings.

An ACIF File Checksum field 302 includes the checksum of the ACIF file in its entirety. An optional Filename field 304 is provided for reference as an aid to the user and/or the application for file verification purposes. A Preprocessor Revision field 306 is provided to document the revision number of the preprocessor editor that created the ACIF, in the event of an incompatibility between the ACIF structure and the system-supported, such as the addition of features provided in the PMCH. An ECO field 308 can be used to provide an engineering change order (ECO) number, as a method of tracking device updates. To prevent unauthorized use, an Encrypted Password field 310 is provided which allows the device update if a password is verified.

A group of fields 312 & 314 are provided in the PMCH to identify ‘N’ possible devices that use the same firmware image. In FIG. 5, six (6) fields are shown for each group 312 and 314, however additional fields could be added as needed. These fields are pointers into a data storage area 320 that contains both INQUIRY and MODE data that identify and validate the device(s) for update. These groups of fields, independent of each other, identify each of the ‘N’ supported devices. As shown in 312 and 314, the MODE fields may be used to specify OLD and NEW settings for two of four possible MODE data types, the Default MODE as well as the Saved MODE settings. If desired, additional fields could be added to support the remaining two MODE types, Changeable and Current. The applet could, if desired, make use of these MODE fields to configure a device.

For each group of fields 312 and 314 specifying a device, a CAP Instruction Sequence field 316 is provided which defines the sequence of operations to be performed to the specific device during the codeload and/or MODE update processes. An End-Of-List marker 318 signifies the end of the device information.

A Storage Area field 320 contains the new and old INQUIRY and MODE data for all supported devices. The respective pointer fields for each device, as detailed above, reference this storage area in the device update process. Following this data area is another End-Of-List marker 322 to signify the end of the data storage area field.

The Encrypted Binary Firmware Image field 324 contains the new firmware image, as provided by the device manufacturer, which is to be loaded into the device. For security purposes, an encryption algorithm may be used to protect image tampering. Finally, a Firmware Image Checksum field 326 is provided to verify the integrity of the image before the code load operation.

It is understood that the arrangement of the master configuration header is a matter of choice and could be varied within a particular application.

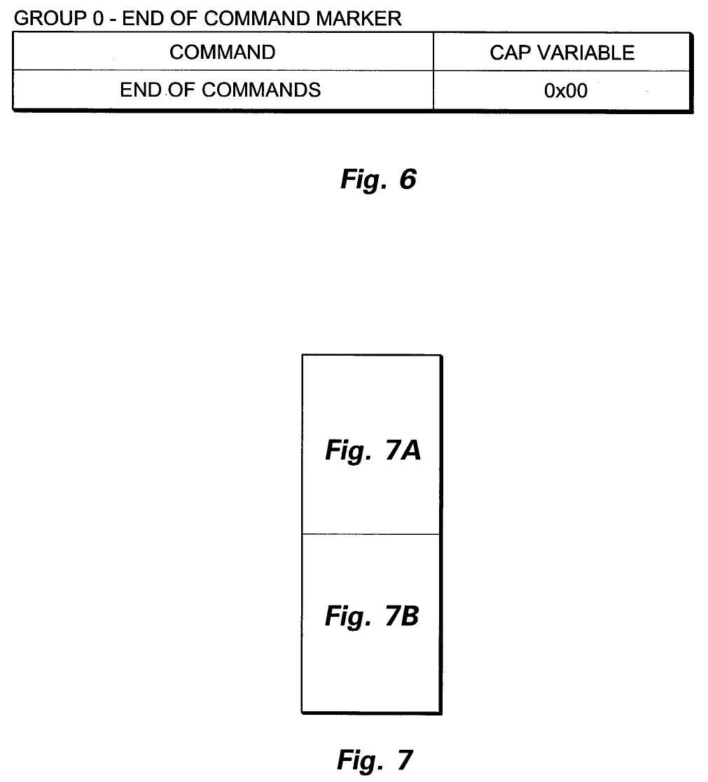

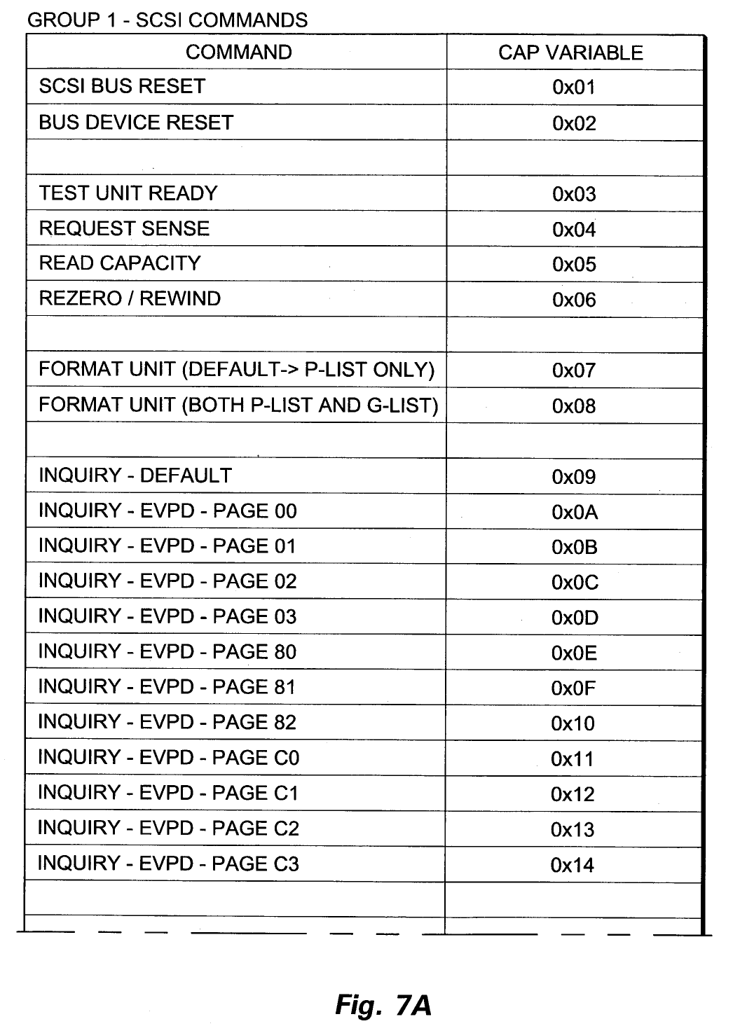

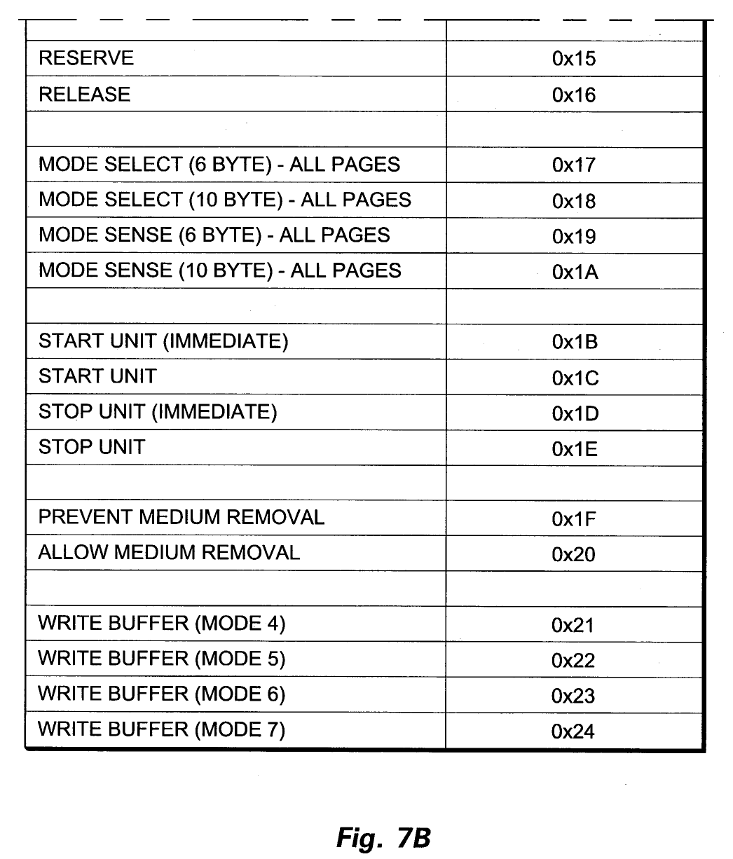

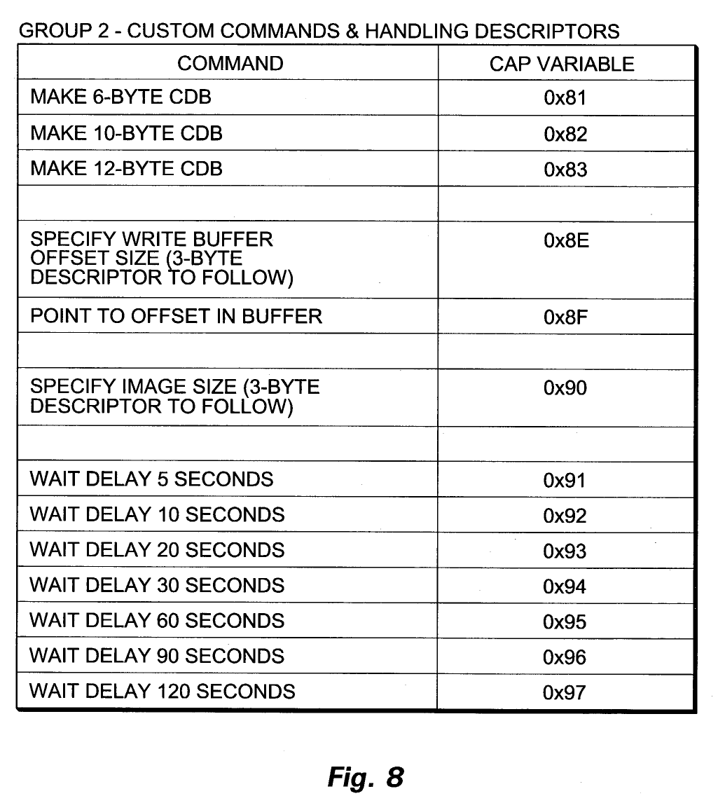

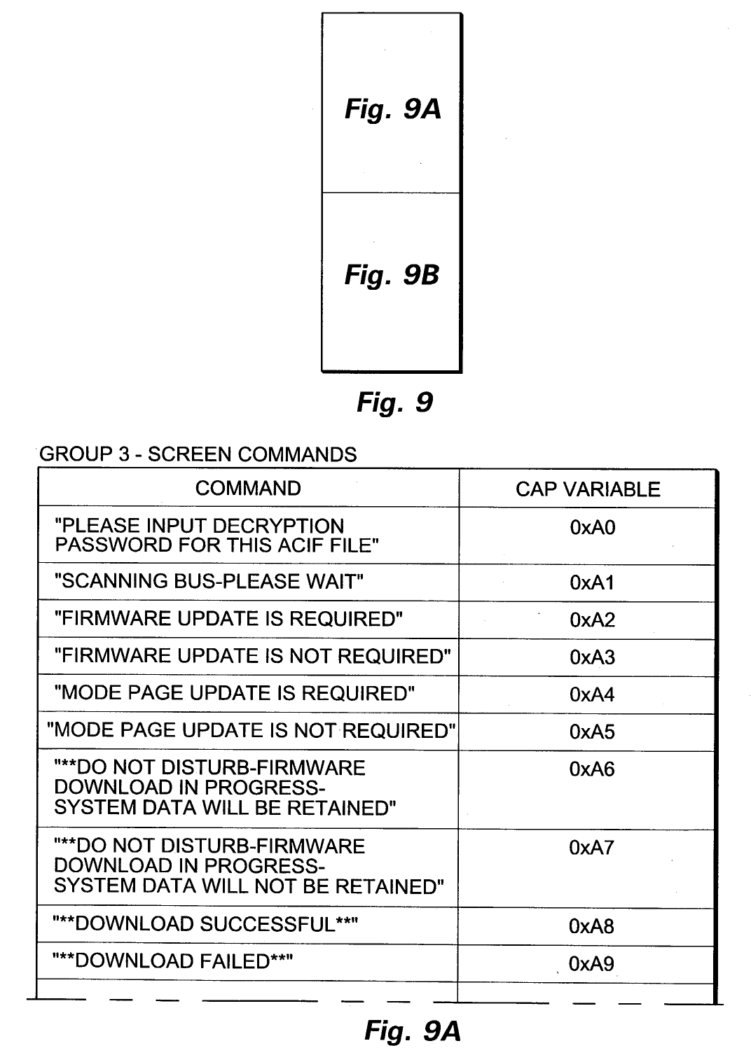

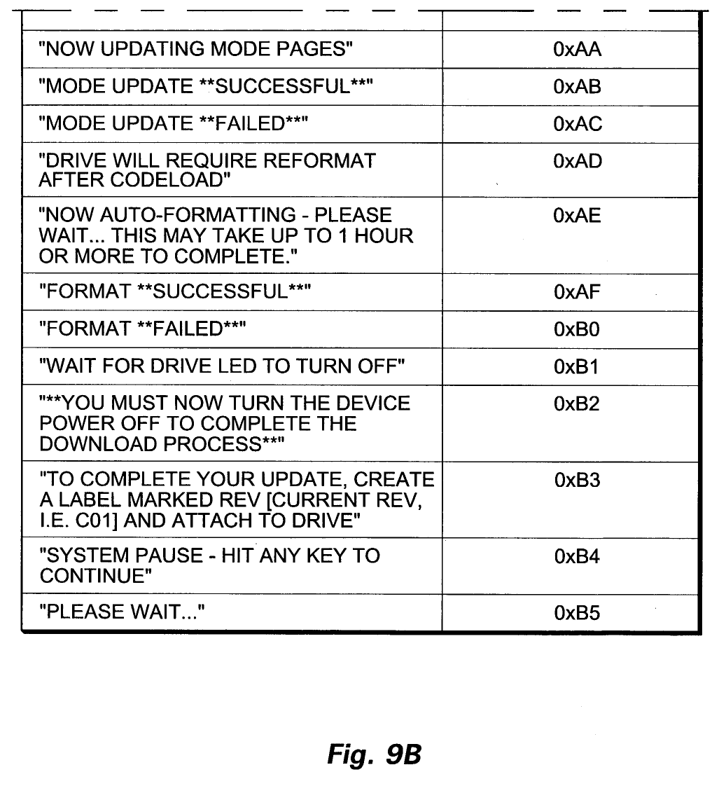

The CAP variable definitions are categorized into four groups including an end of command marker, a set of SCSI commands, a set of custom commands and handling descriptors, and a set of screen commands for passing data to the user. These CAP commands are shown in FIGS. 6-9. It is understood that the CAP commands shown and described herein are by way of example only, and the name or value assigned to each command is matter of choice depending on the particular implementation.

FIG. 10 is a flow diagram illustrating steps of an exemplary method for downloading firmware using the data structure for a peripheral master configuration header. Operation 1000, which may be performed by an agent 100, 102 scans the peripheral bus to identify storage devices connected to the storage subsystem. This information may be transferred to the applet at its request. The storage devices located may be displayed to the user for selection. In operation 1002, the user selects a list of devices to update. Operation 1004 queries the user for a password. The password supplied by the user may be compared with the password in the ACIF file to insure that a non-authorized user cannot access and manipulate the storage device. Operation 1006 determines if the password is correct, and if not, access is denied and control is passed to the end of the process 1040.

If the user provides a proper password, operation 1006 passes control to operation 1010. Operation 1010 retrieves the Inquiry string from the file header for device validation. Operation 1012 retrieves the device Inquiry and Mode data from all selected devices through an agent 100, 102. Operation 1014 compares the Inquiry string from the image file with the Inquiry data from the selected devices.

Decision operation 1016 determines if all selected devices are updateable. If true, control passes to operation 1030. If there are any non-updateable devices in the list, then control is passed to operation 1018, which displays the list of invalid devices. In operation 1020, invalid devices are removed from the list of devices selected. Operation 1022 determines if there are any updateable remaining devices in the list. If the list is non-empty as determined by operation 1022, then control is passed to operation 1030. If the list is empty, then control is passed to End-Of-Process 1040.

Since both the validity of the user and the validity of the particular storage device(s) have been confirmed by operations 1006 and 1016, operation 1030 transfers the firmware file to the agent(s). Operation 1032 instructs the agent(s) to download the firmware to the particular storage device(s). An exemplary embodiment supports a ‘segmented-download’ feature.

A segmented-download occurs by transmitting the firmware image to the device in fixed-length sections (for example, 32K) using a series of Write Buffer commands which define both the transmission length and offset into the firmware image. The segment size may vary between devices. Using this method, the agent transmits the file segments to all selected devices. By doing parallel transmission, the devices(s) receive the final Write Buffer segments and perform the reprogramming process simultaneously, thus reducing the overall codeload and maintenance time. In large disk arrays, this time could be significantly large. In one embodiment what would have taken several minutes, or perhaps hours, to perform on a large disk array update may be reduced to just a few minutes.

The update process may be controlled through the use of CAP commands and instructions present in the master configuration header. The storage device may be locked during firmware download preventing other applications from using it. Following the updates, operation 1036 rescans the peripheral bus to get new Inquiry data from the devices. The new Inquiry data may be compared against the new Inquiry strings from the master configuration header 316 for update verification. Thus, FIG. 10 illustrates the secure downloading of firmware to devices over a network in a client/server architecture.

FIG. 11 illustrates an alternative data structure for a configuration header in accordance with another embodiment. The header 1100 shown in FIG. 11 has fewer data fields than the header shown in FIG. 5. Referring to FIG. 11, the header 1100 has a field 1102 for the header size, which is the size of the header itself. Fields for the revision number 1104 of the header, the vendor identification 1106, and the product identification 1108 are provided in the header. The field FW Rev 1110 indicates the revision of the firmware image.

The encrypted password 1112 is specific to the firmware file. The encrypted password allows the client to ensure that unauthorized users will not be allowed to download the firmware. The agent compares the existing version of the firmware on the device and the version to be downloaded. Appropriate warning is generated to the user if a discrepancy is identified.

The comment field 1114 is used to convey information that will be useful to the user at firmware load time. The firmware supplier/distributor specifies the information that goes into the comment field at preprocessing time. The FW length field 1116 specifies the size of the firmware image.

Finally, the firmware image 1118 is attached to the header. The firmware image will be used as needed when a codeload is specified. Optionally, a checksum could follow the firmware image field to ensure proper reception of the file without any transmission errors.

In a small computing system where there are only few storage devices, updating the device firmware may be done one at a time. By contrast, in larger computing environment, there are many storage devices of the same type in one or more subsystems connected to a host, and often distributed amongst multiple systems. Using techniques described herein, firmware may be downloaded to multiple devices contemporaneously or simultaneously. The devices could be in one subsystem or across multiple subsystems within a host or amongst multiple hosts. The agent spawns multiple threads, one for each storage device, and loads the firmware simultaneously.

In the case of multiple contemporaneous or simultaneous downloads, a file can be sent from the applet to the agent in various ways. In one example, the firmware file may be transferred from the applet to the agent once for each storage device. This is a time consuming process. In a second example, a firmware file may be transferred from an applet to an agent once, and the agent is instructed to load the firmware on multiple storage devices by providing a list of storage devices that are managed by that agent.

In a third example, if the storage devices are spread across multiple agents in a host, then file transfer from the applet to the agent may be performed once and stored on the host. Each agent may be provided with a list of storage devices managed by it, and requested to perform firmware download using the firmware file that was previously transferred.

In a fourth example, where firmware download is performed across multiple hosts, the steps of the third example can be used once for each host in a serial fashion. Alternatively, the firmware file can be transferred once by multicasting it to the set of hosts. Then the agents are provided with a list of storage devices to perform the firmware download.

To ensure that the firmware file has been successfully received, the agent may check the byte count of the received file with the byte count of the original file. Where there is checksum, the agent may perform a checksum to ensure error free reception of the file.

The agent may communicate with the clients while the firmware download is in progress. To ensure that the download is not interrupted due to network problems, the agent may create a separate thread (or process) to download the firmware to the storage device. In one example of the present invention, the main agent thread (or process) communicates with the client, and the download thread (or process) and the main agent thread (or process) communicates through interthread (or interprocess) communication mechanism.

While firmware download is in progress, termination of the agent and/or the firmware download process may render the storage device unusable. In order to prevent such a mistake, the agent may catch termination signals and warns the user appropriately, thus improving firmware download reliability. Thus, the thread-per-download coupled with signal handling and validation enables secure reliable simultaneous firmware download with high performance.

### MULTI-LEVEL SECURITY

As discussed above, administering storage device should be a secure operation to ensure that unauthorized users do not access the storage subsystem. In an exemplary embodiment, security can be provided at multiple levels, including (1) system-level authentication, (2) multi-level password security; (3) user-level authentication, (4) message-level authentication, and (5) encryption.

With system-level authentication, a security check is performed at the system level. An agent manager 106 maintains the list of client systems that are authorized to establish communication with the agents 100, 102 running on its host. When a connection request is received from a client, agent manager 106 checks a security database 104 to see whether the client system is an authorized system. Agent manager 106 may refuse to permit unauthorized clients to establish connection with its agents.

With multi-level password security, the storage administrative functions are classified into various sets of functions. Each set of functions is assigned different password level. For example, some basic monitoring operations may not have any password at all. On the other hand, operations such as firmware download are classified to have highest level of password protection. Based on the operation performed, the user must specify the appropriate level of password.

With user-level authentication, various levels of privileges may be created, and each user is assigned a privilege level. Based on the level of privilege, users perform different level of management functions without the need to specify multi-level passwords described earlier. In other words, when the users log into the management station, they automatically get the privilege level assigned to them. A lower privileged user could perform upper level functions by going through the multi-level password security mechanism described above.

With message level authentication, the client includes its authentication information with each message sent to the server. It will be appreciated that processing the authentication information requires extra computing time. As a compromise, authentication information could be included on selected message types only, instead of all messages.

With encryption, information exchanged between the client and the server is encrypted. Again to minimize processing overhead, selected information could be encrypted.

### ASYNCHRONOUS NOTIFICATION

The status of a storage device can change at any given time. For example, a normally operating disk can fail suddenly, or a fan may stop running and the temperature of a cabinet may rise beyond the critical limit. It is important that the administrator is notified of the status changes in the subsystems immediately so that appropriate action can be taken before major failures occur. In an exemplary embodiment, when an agent detects an important status change in a component of a storage subsystem, the agent sends an event notification message (trap) to one or more designated asynchronous event servers (AES). The AES in turn sends messages (traps) to the applet manager, to the appropriate applet, and or to an external entity. In addition, the AES delivers a message to the designated user. In one example, the message is in the form of a pager message and/or an electronic mail message, marked urgent if needed.

One or more AES servers run in the networked environment. In one example of the embodiment, the notification workload is distributed among multiple AESs. In another embodiment, one AES acts as the primary AES and handle all notifications. In this case, other AESs, designated as secondary AESs, are in the standby mode. When the primary AES fails, any one of the secondary AESs will become the primary AES after performing arbitration among secondary AESs. To keep all AESs synchronized, the notifications are sent from the agents in a multi-cast mode or the AESs exchange information among themselves. Broadcast mechanism is also possible, however, it has less security since anyone listening on the network can get it. The primary AES notifies its presence by transmitting an “alive” message periodically to the secondary AESs.

The distributed AESs technique provides better performance by sharing the workload. The primary-secondary AES mechanism provides enhanced reliability since any AES can become a master by arbitration when an existing master AES fails. With persistent data storage at the AES and the retry (instead of one-time) feature increases the reliability of notification.

### ALTERNATE EMBODIMENT

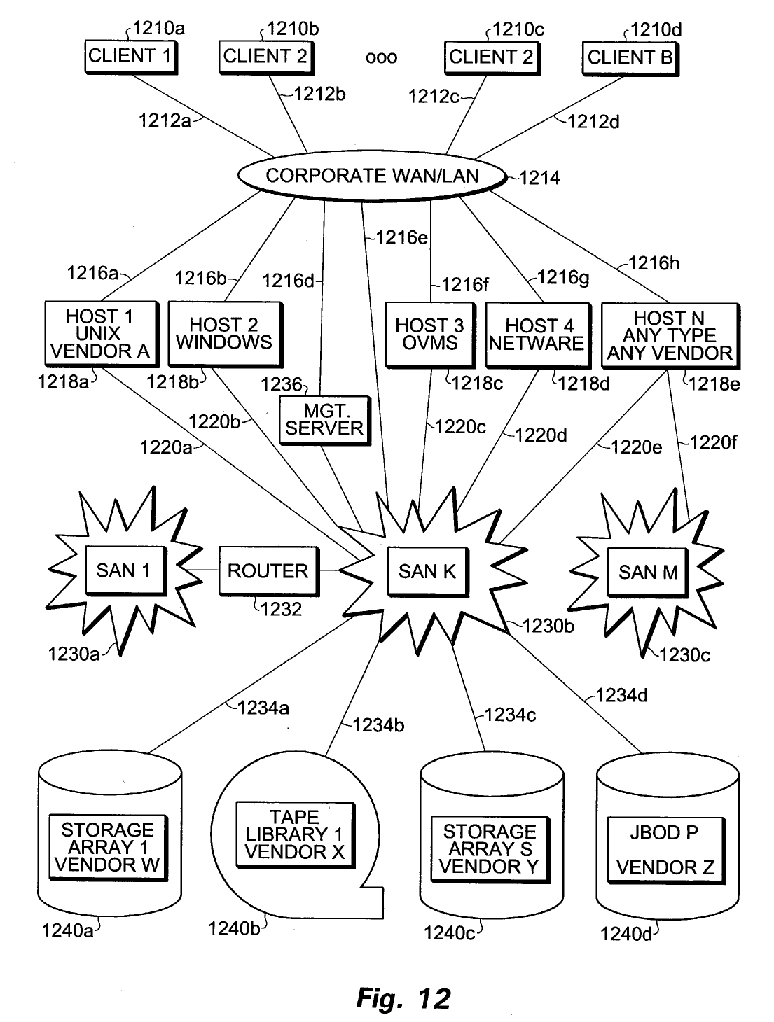

In an alternate embodiment, systems and methods for performing schedulable downloads in storage networks comprising one or more storage area networks (SANs) are provided. An exemplary storage network is depicted in FIG. 12. Referring to FIG. 12, a plurality of clients 1210a, 1210b, 1210c, 1210d may be connected to a suitable communication network 1214 via suitable communication connections 1212a, 1212b, 1212c, 1212d. Clients may be any computer-based processing device, e.g., a computer workstation, a laptop, a handheld computer, etc. Communication network 1214 typically is a private communication network such as a corporate LAN or WAN, but may be a public communication network such as, e.g., the Internet. Communication connections 1212a, 1212b, 1212c,1212d, may follow a conventional protocol, e.g., TCP/IP, over a conventional medium, e.g., a wired connection or a wireless connection.

A plurality of hosts 1218a, 1218b, 1218c, 1218d, 1218e maintain communication connections 1216a, 1216b, 1216f, 1216g, 1216h with communication network 1214. Hosts 1218a, 1218b, 1218c, 1218d, 1218e may be conventional host computers in a storage network, i.e., host computers may function as servers to receive requests from clients 1210a, 1210b, 1210c, 1210d for resources from the storage systems, to process the requests, and to communicate the requests to one or more SANs 1230a, 1230b, 1230c over a suitable communication link 1220a, 1220b, 1220c, 1220d, 1220e, 1220f, which may be governed by a suitable protocol, e.g., TCP/IP, Fibre Channel (FC), SCSI, iSCSI or Ethernet.

Each SAN may include a plurality of storage arrays (or libraries) 1240a, 1240b, 1240c, 1240d, each of which may include a plurality of storage devices such as, e.g., hard disk drives, tape drives, CD ROM drives, etc. Typically, each storage device resides on (or is associated with) a controller that has a unique network address that is known to a host bus adapter (HBA) in the SAN that communicates with the host computers 1218a, 1218b, 1218c, 1218d, 1218e. The storage network may also include one or more switches or routers 1232 that provide communication between SANs 1230a, 1230b, 1230c, and one or more management servers 1236 for managing operations of the storage network. As will be appreciated by one of skill in the SAN arts, the components and organization of the storage network depicted in FIG. 12 are conventional, and therefore the various components are not explained in greater detail herein.

Typically, large organizations, i.e., enterprises, may construct storage networks over time using components from different vendors. For example, host 1218a may be a UNIX-based server, host 1218b may be a Windows® based server, host 1218c may be an OVMS-based server, host 1218d may be a Netware-based server. Similarly, storage arrays 1240a, 1240b, 1240c, 1240d may be purchased from different vendors, or may be from the same vendor but may be a different model or configuration. Each vendor and/or model may have a different method for updating software (including firmware) executing on their device(s), which complicates the process of updating software in the storage network.

The system and method described herein addresses this issue. Broadly, the system comprises a software process executing on at least one management server and a software process executing on a plurality of, and preferably each, host in the system. The software process executes a device discovery process to discover the various devices in the storage network and performs a topology discovery process to determine the connectivity between devices. The process also performs a path determination process to determine desirable paths between devices for loading software and permits a schedulable software loading process. Each of these processes is described below.

### HOST AGENT ARCHITECTURE

In an exemplary embodiment, a host agent software module runs on at least one host system connected to the SAN(s). The host agent software module executes device discovery procedures for Host Bus Adapters (HBAs) and storage arrays in the SAN(s) and reports the results to the management software on a management server such as, e.g., management server 1236. In one embodiment, the host agent software module receives device discovery requests from one or more management servers, and executes device discovery procedures in response to the device discovery requests. Alternately or in addition, the host agent software module may execute device discovery procedures on a periodic basis.

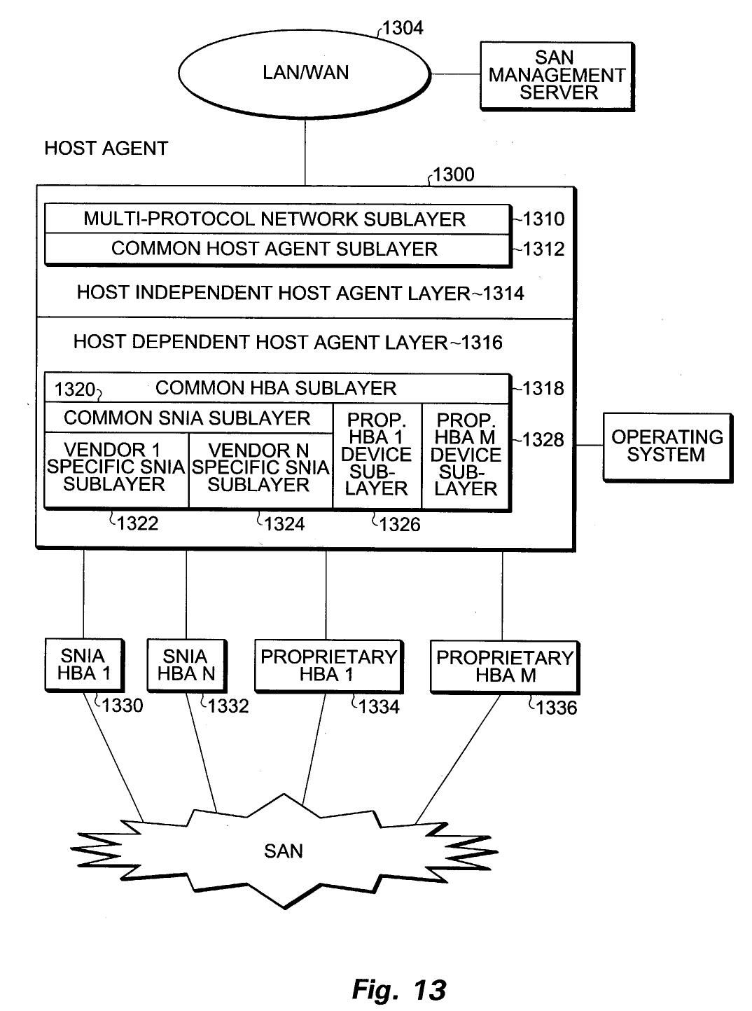

FIG. 13 is a schematic depiction of an exemplary architecture for a host agent software module. Referring to FIG. 13, host agent may include a host independent layer 1314, and a host dependent layer 1316. Host independent layer 1314 may remain the same for all host platforms, e.g., Windows, UNIX, OVMS, Netware and/or others, while the host-dependent layer 1316 may be specific to the particular platform on which the host operates.

The host-independent layer 1314 functions as an interface to facilitate communications with one or more management servers . This layer may be further subdivided into a multiprotocol sublayer 1310 and a common host agent sublayer 1312. Multiprotocol sublayer 1310 is a communication interface that permits the host agent to communicate with numerous LAN/WAN networks 1304, e.g., Ethernet, Token Ring, Internet using protocols such as TCP/IP, SNMP, RMI, RPC, Socket, SOAP/XML, and HTTP. The common host agent sublayer 1312 provides the rest of the host-independent components in the agent such as command handling and data management.

Host-dependent layer 1316 includes software modules that are host platform dependent. A common HBA sublayer 1318 provides a unified interface to the upper layer components in the host agent hiding HBA specific characteristics.

A common SNIA (Storage Network Industry Association) sublayer 1320 supports SNIA compliant HBAs. This layer supports the HBA features described in the SNIA standard specification. It hides vendor HBA specific details from the upper layer.

Vendor-dependent SNIA sublayers 1322, 1324 typically include the SNIA library provided by the vendor for the vendor's HBA. This sublayer interacts with the HBA hardware and obtains HBA attributes such as World Wide Port Name (WWPN), number of ports, serial number, firmware version, etc., from the HBA.

Not all HBAs are SNIA compliant. Several HBAs provide only proprietary interfaces. Proprietary HBA device sublayer 1326, 1328 supports HBAs that are not SNIA compliant. This sublayer interacts with the HBA hardware and obtains HBA attributes such as World Wide Port Name (WWPN), number of ports, serial number, firmware version, etc., from the HBA.

The exemplary host agent architecture depicted in FIG. 13 provides a modular and layered design, which facilitates development, testing, installation, and maintenance. In addition, it is easier and faster to develop host agents for various platforms since only the host specific layer need to be developed.

Host agent 1300 may also comprise modules that can discover other SAN assets such as software applications running in the host including their versions and LUNs. To discover application software, the host agent may use operating system and application specific features. The SCSI protocol is used to discover LUNs. These components are not explicitly shown in FIG. 13.

### SCHEDULABLE SOFTWARE DOWNLOAD MODULE

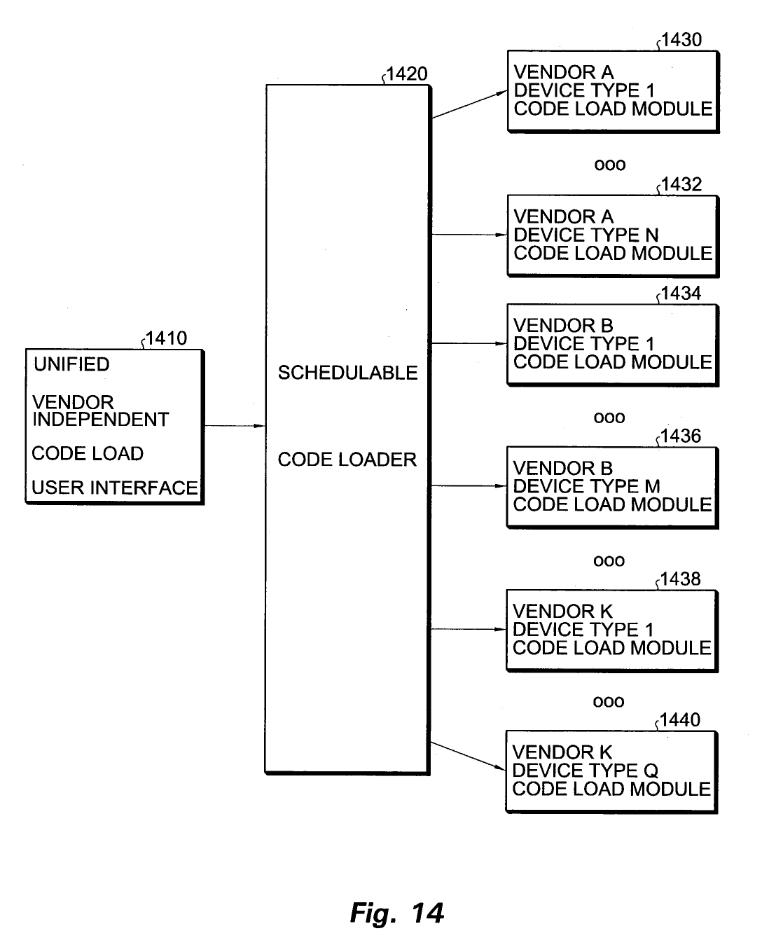

FIG. 14 is a block diagram illustrating components of a multivendor device software download system. Some components of the system may be implemented as one or more software modules executable on a processor, while other components may be hardware components, or a combination of hardware and software. Referring to FIG. 14, the system may comprise a Unified Vendor Independent Codeload User Interface 1410. User interface 1410 may be a graphical user interface (GUI), Command Line Interface (CLI) or a text interface. A user interacts with the system through user interface 1410.

The system further comprises a schedulable code loader module 1420 that receives requests to download software to one or more devices in the storage system, processes the requests, and executes the software download, if appropriate. Codeload module 1420 is explained in greater detail below. Codeload module 1420 interacts with a plurality of vendor-specific (and/or device-specific) software download modules 1430-1440 to implement software/firmware download. Download modules 1430-1440 may be supplied by vendors of particular hardware devices.

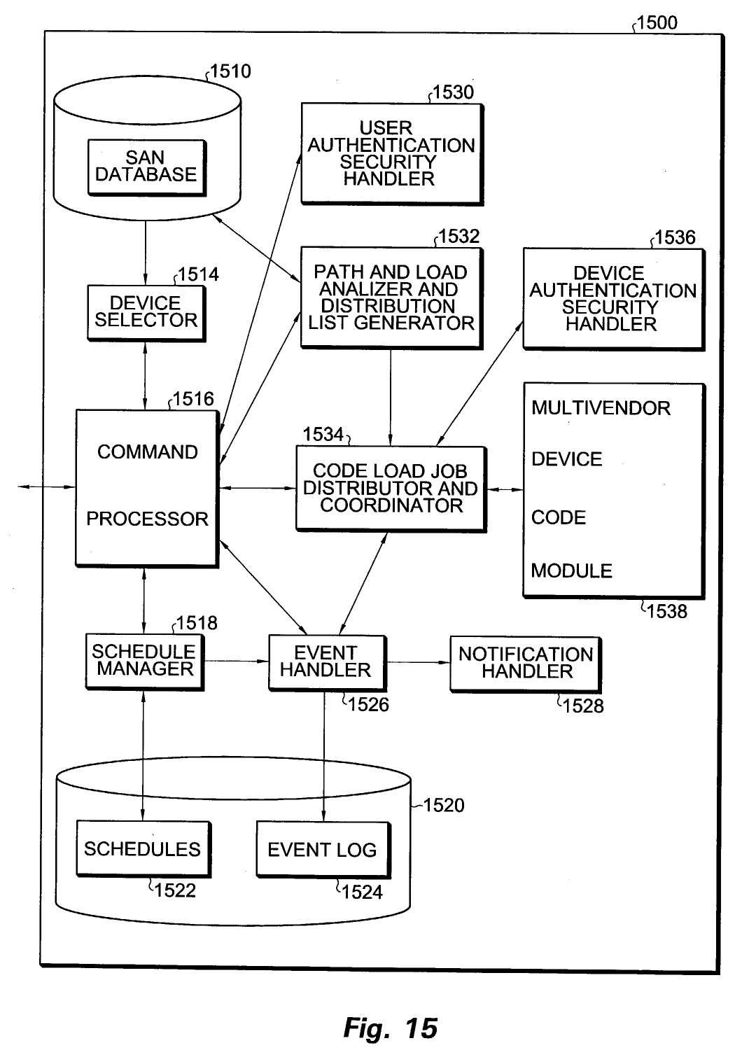

FIG. 15 is a block diagram illustrating components of an exemplary Schedulable Code Loader 1500 for use in a storage network. Some components of the module 1500 may be implemented as one or more software modules executable on a processor, while other components may be hardware components, or a combination of hardware and software.

Referring to FIG. 15, module 1500 comprises a SAN database 1510 that stores information about the various devices in the SAN and the communication connections in the SAN. A second database 1520 comprises schedules 1522 for software downloads and an event log 1524 for logging events that take place in the storage network.

A command processor 1516 functions as an interface between module 1500 and a user, which may be a human user, e.g., a network manager, or another client computer. Command processor 1516 supports multiple client interfaces such as Graphical user Interface (GUI), Command Line User Interface (CLI/CLUI), import and export Application Programmatic Interfaces (APIs). Command processor 1516 receives and processes commands and interacts with other components of module 1500 to download software to one or more devices in the storage network. Command processor 1516 interacts with a device selector module 1514, which in turn communicates with SAN database to select one or more devices to which software/firmware is to be downloaded.

Command processor 1516 also communicates with a schedule manager 1518 and an event handler 1526. Schedule manager 1518 communicates with the schedule database 1522 to manage scheduled downloads of software to devices in the storage network. Event handler 1526 logs various events to the Event Log 1524 reflecting the status of software/firmware download process. Events have attributes such as device name, device identifier, severity, date and time, event type, event description, and so on. Notification handler 1528 communicates some of the events having certain severity levels to one or more SAN administrators as configured by the administrators. The notification may be sent through one or more means such as paging, email, visual GUI at the management station, and so on.

Command processor 1516 communicates with a Path and Load Analyzer and Distribution List Generator (PLADLG) 1532 that uses path and load information from the SAN database to determine paths for software to be downloaded to devices in the storage network. Command processor 1516 also communicates with a Code Load Job Distributor and Coordinator (CLJDC) module 1534 that coordinates the distribution and download of software. The CLJDC module 1534 receives the distribution list from the PLADLG 1532. The CLJDC module communicates with the Multivendor Device Download Module 1538 to download the software to devices in the storage network. Multivendor Device Download module 1538 invokes the vendor device specific download modules 1430-1440 to execute a software download to a specific device.

Distributor and coordinator module 1534 uses the device authentication security handler 1536 to authenticate the user to the devices to which software is to be downloaded.

A user authentication security handler 1530 checks the user, e.g., by checking the user's username and password against a list of approved users to ensure that the user has the authority and privilege to initiate software download.

### SYSTEM OPERATION

Having described various components of an exemplary system for downloading software, operation of an exemplary system will now be discussed. Broadly speaking, the system implements three major operations: device discovery, path determination, and software download. Each of these processes is discussed below.

### DEVICE DISCOVERY

Device discovery refers to the process of identifying the various devices in the storage network and collecting information about the devices and software and or firmware resident on the devices. In an exemplary embodiment, a variety of methods may be used to discover devices in the storage system. As described above, SAN management software may be installed and configured on one or more SAN management server systems, and configure the servers to manage the SANs. During configuration, the administrator may specify a range of IP addresses used in the SAN(s). Periodically, the SAN management software may execute a device discovery process that launches inquires to obtain information about the various devices in the storage system. The discovery process may use a plurality of techniques to gather information, which may be stored in a suitable storage medium in the management server, i.e., a database. Also, the host agent software module described above may be installed on one or more (and preferably all) hosts in the system to assist in the device discovery process.

For example, Simple Network Management Protocol (SNMP) may be used to discover SNMP devices such as switches, hubs, bridges, and routers. To identify a device using the IP address, SAN management software in a management server may issue an SNMP Get operation on the device to read the SysObjectID of the device. These SysObjectIDs may be stored in a suitable memory location and used to identify the device(s) based on the value read for the SysObjectID.

Some devices in the SAN(s) may not support the SNMP protocol, for example, storage devices. In this case, if there is a proxy SNMP agent for the device(s), then the proxy SNMP agent may be used to discover the devices. For example, SAN management software in a management server may issue an SNMP Get operation on the proxy to read the SysObjectID of the device.

SCSI may be used to discover storage devices such as disk storage arrays, JBOD and libraries that do not support SNMP agents. SCSI commands such as inquiry, mode pages, etc., may be issued from the hosts and/or management stations. SCSI devices in the SAN and the direct attached storage devices (DASs) respond to these commands. The results of these commands may be analyzed to identify the storage devices that exist in the SAN. To discover SCSI devices from hosts, host agent software installed on the hosts may issue a SCSI commands such as inquiry and mode page. Information about the identified devices may be transmitted to one or more SAN management servers and stored in a suitable storage medium, e.g., a database.

Most of the hosts in the SAN(s) are neither SNMP devices nor SCSI devices rather they are IP devices. The host agent running on the host may discover information about the local host, such as information about the hardware platform, operating system (e.g., type and version), and information about applications running on the host including versions. The host agent may communicate this information to the SAN management servers for storage in a suitable storage medium, e.g., a database.

Each host in the SAN(s) may include one or more host bus adapters (HBAs) that are used to connect the host to one or more SANs. The HBAs may be from the same vendor or from multiple vendors. The host agent running on the host discovers the HBAs in the host. Several attributes such as vendor, model, firmware version, number of ports, and world wide port name may be obtained as part of the discovery. The host agent may be capable of discovering multivendor HBAs, including standards-based HBAs, and proprietary HBAs. It may use standard based device drivers, vendor specific device drivers and or the information in the operating system to discover proprietary HBAs.

The host agent software modules may also compute and/or collect the load on the host. Load factors may include SAN I/O load, CPU load, and others. Information such as CPU load may be collected from the operating system, while storage load information may be computed based on the amount of SAN I/O from the host to various storage devices in the SAN. The load information may be sent to the SAN management server and stored in a suitable storage medium, e.g., a database.

In sum, the SAN management software and the host agent software implements a discovery process that may use several different procedures to collect device information from switches, bridges, routers, hosts, storage devices, and other devices in the SAN(s) of the storage network. This information may be stored in a suitable storage medium, e.g., a SAN database.

### PATH DETERMINATION

Path determination refers to the process of determining a path from a management server or a host to a network device. In an exemplary embodiment, SAN management software determines the topology of the SAN(s) in the storage network and the paths from one or more management servers and hosts to the devices in the network. One of skill in the storage arts will appreciate that the SAN management software can determine the path between the hosts and storage devices based on the storage devices the host can access. Alternatively, the SAN management software may determine the path to storage devices based on the physical connectivity of devices.

In the latter case, the SAN management software may discover the connectivity between various ports of the switches in the SAN. In an exemplary embodiment, connectivity information may be gathered by the SAN management software using a repetitive process of querying switches to access their port and node information. Connectivity may be computed using the World Wide Port Names (WWPN) of the ports in each switch, the World Wide Node Names (WWNN) of the switches, and the WWPN of the “connected-to” port information in the switches.

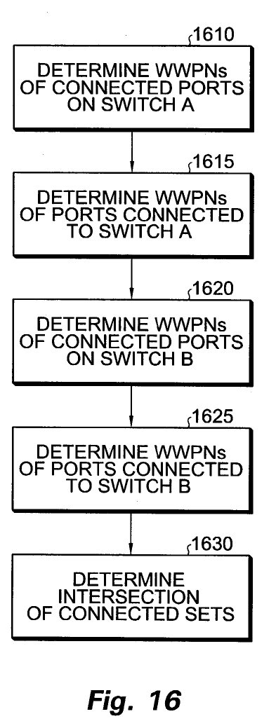

FIG. 16 is a flowchart illustrating an exemplary process for determining the connectivity between two switches, A and B, in a storage network. At step 1610 the SAN management software queries switch A to determine the World Wide Port Names (WWPNs) of the set of switch ports, i.e., {AP1, AP2, . . . APn}. At step 1615, the SAN management software queries switch A to determine the WWPNs of the connected-to ports of switch A, i.e., {AC1, AC2, . . . ACn}. One of skill in the art will recognize that switches and routers maintain a data table of WWPNs for each port, and the WWPNs of the port connected to each port. One of skill in the art will also recognize that the queries may be combined into a single query.

At step 1620 the SAN management software queries switch B to determine the World Wide Port Names (WWPNs) of the set of switch ports, i.e., {BP1, BP2, . . . BPm}. At step 1625, the SAN management software queries switch B to determine the WWPNs of the connected-to ports of a, i.e., {BC1, BC2, . . . BCm}.

At step 1630, the SAN management software computes the intersection of the sets AP and BC. If the intersection set has cardinality >1, then A and B are connected. Otherwise, A and B are not connected. If A and B are connected, then using the members of the sets, AP, AC, BP, and BC, the connectivity between individual ports may be determined.

It will be appreciated that step 1630 could also be performed using the intersection of the sets BP and AC. If the intersection set has cardinality >1, then A and B are connected. Otherwise A and B are not connected. If A and B are connected then, using the members of the sets, BC, BP, AP, and AC, compute connectivity between individual ports.

The process of steps 1610 through 1630 may be repeated for pairs of devices in the storage network. The result will be a mapping of the connectivity of the storage system. This mapping may be stored in a suitable storage medium, e.g., a SAN database.

In an exemplary embodiment, apriori graph theoretical algorithms may be used to enumerate paths between various nodes with minor changes as described in this section. A storage area network may be represented as an undirected graph where each device in the SAN is a vertex in the graph and each link in the SAN is an edge in the graph. One of skill in the storage arts will be familiar with apriori graph algorithms for path enumeration. Accordingly, the construction of a priory graphs is not explained in detail herein. The interested reader is referred to the following publications, the disclosures of which are incorporated by reference in their entirety. Computing shortest paths for any number of hops, by R. Guerin, and A. Orda, IEEE/ACM Transaction on Networking (TON), Volume 10, Issue 5, Oct. 2002. Faster shortest-path algorithms for planar graphs, by P. Klein, A. Rao, M. Rauch, S. Subramanian, Annual ACM Symposium on Theory of Computing, Montreal, Quebec, Canada, 1994. Shortest path algorithm for edge-sparse graphs, by R. Wagner, Journal of ACM (JACM), Volume 23, Issue 1, Jan. 1976. Efficient algorithms for shortest paths in sparse networks, by D. Johnson, Journal of ACM (JACM), Volume 24, Issue 1, Jan. 1977. Efficient parallel algorithms for path problems in directed graphs, by J. M. Lucas, and M. G. Sackrowit, Proceedings of the first Annual ACM Symposium on Parallel Algorithms and Architectures, Santa Fe, N.Mex., USA, 1989.

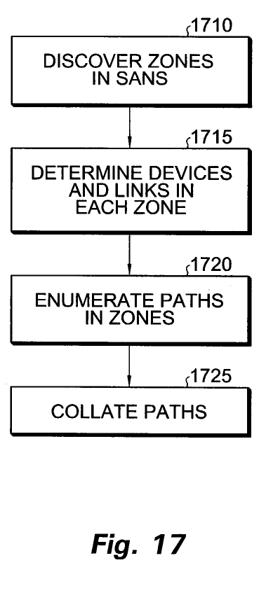

Many SANs provide zoning features that restrict which hosts and management severs can access particular storage devices through particular sections of the SAN. These zones can be overlapping. FIG. 17 is a flow chart illustrating an exemplary method for computing paths in the SAN(s) in the storage system.

At step 1710, the SAN management software obtains the zones in each SAN from the zoning configuration performed by the administrators.

At step 1715, a subgraph may be constructed for each zone in the SAN with appropriate devices and links. Each subgraph may be an undirected graph where each device in the zone is a vertex in the graph and each link in the zone is an edge in the graph.

At step 1720, each of the paths in the subgraph may be enumerated, e.g., using an apriori graph theoretical algorithm. At step 1725, the paths are collated and a set of all paths in the SAN is created. Steps 1710-1725 may be repeated for each SAN in the storage system to map all the paths in the SAN(s) in the storage network.

Paths in a graph may be weighted in proportion to the load on the path. This may be useful for systems that perform a load-based distribution of code. Weighted paths must be computed to distribute software based on the load. Weights for various links in the SAN may be assigned based on the load on the devices and ports at the time of the software distribution. Software downloads can then be distributed starting from the least cost path to the highest cost path, which will result in an efficient code load. Computation without weighting the paths is analogous to computing with equal weights for all links and nodes. If software distribution is not load-based, then only path information is required.

In sum, the management software implements a process that determines the path(s) between management server(s) and or hosts and devices in the storage system, an optionally allocates a weight to the path as a function of the utilization of the path. The path information may then be stored in a suitable storage medium, e.g., a SAN database 1510.

### SOFTWARE DOWNLOAD

Software download refers to the process of downloading software to one or more devices in the storage network. In practice, a network administrator can start the system from a client computer or from a management server. In one embodiment, the user interface 1410 displays a list of SANs and the list of devices in each SAN. The network administrator may specify selection criteria to select a set of devices from one or more SANs for a scheduled software download. For example, with reference to FIG. 12, a network administrator may select all devices from Vendor W in SANs 1 1230a through SAN K for download with firmware Version 1.0. The command process 1516 will receive the request from the user interface 1410, transmits the request to the Device Selector 1514, which queries the SAN database 1510 to retrieve devices in the storage system matching the search criteria. These devices may be displayed to the network administrator on the user interface 1410.

The administrator can further reduce the selection by picking desired devices from the list, or may select all of them. Thus, selection criteria may be specified at several levels. Once the final device list is identified, the network administrator can specify a schedule for code load. The scheduler may display a calendar on user interface 1410 to specify the date and time to perform the code load. The administrator can specify variety of scheduling choices. For example, one could state to perform code load during certain hours of the day. Devices that could not be loaded during the specified interval in one day may automatically be entered in the next scheduled day at the specified time interval. This process could go on for several days until code load for all devices are completed. Alternately, once the code load starts, it can carry on without any break until all devices are loaded. The scheduling can also indicate to perform code load after regular office hours during weekdays and anytime during weekends. The administrator can cancel, stop or edit the code load schedule anytime. Thus, the scheduler provides flexibility in code load.

The devices and the schedule selected by the network administrator may be forwarded to the schedule manager 1518, which handles all the user specified schedules. When the scheduled time arrives, the schedule manager 1518 generates appropriate event(s) to the event handler 1526, which in turn triggers the distributor and coordinator module 1534. The distributor and coordinator module 1534 transmits the device information and the software to be downloaded to the appropriate servers and or hosts according to the path determined. The distribution of the software may occur at the scheduled time or ahead of time based on the scheduling. Various methods explained earlier could be used to distribute the software. The multivendor device download module 1538, invokes the appropriate vendor-specific and device-specific download module 1430-1440 to implement download the software to the selected device(s).

The Code Load Coordinator 1534 manages and coordinates several codeloads performed in parallel from servers and hosts at the same time based on the number of devices and the schedule specified by the administrator. Based on the status of completion of the codeload, appropriate events are generated and logged into the Event Log. Some of the events will result in sending notification to one or more administrators according to the user specified configuration.

Accordingly, described herein is a schedulable, distributed, parallel codeload system for downloading software/firmware to a plurality of devices in a storage network. The system executes a device discovery process that collects information about devices in the storage network, including the software resident on the devices. The system computes information about the loads, and the path(s) between the management server(s)/hosts in the storage network and the devices. This information may be stored in one or more databases throughout the storage network. A software process executing on a server in the storage network permits a user to select devices in the storage system for software downloads and a schedule for executing the downloads. At the scheduled time, the system downloads the software to the selected device(s).

Although the invention has been described and illustrated with a certain degree of particularity, it is understood that the present disclosure has been made only by way of example, and that numerous changes in the combination and arrangement of parts can be resorted to by those skilled in the art without departing from the spirit and scope of the invention, as hereinafter claimed.

The words “comprise,” “comprising,” “include,” “including,” and “includes” when used in this specification and in the following claims are intended to specify the presence of stated features, integers, components, or steps, but they do not preclude the presence or addition of one or more other features, integers, components, steps, or groups.

What is claimed is:

1. A method for updating a software module in a plurality of devices in a storage network, comprising:
discovering and generating a list of devices in a storage network;
determining the topology of the storage network;
receiving a request to update software of a plurality of devices, wherein the request includes a file comprising a software module and a data header, the data header including a list of valid devices in which the firmware may be used;
authenticating the request;
validating the list of devices with the firmware;
authenticating to the devices identified in the request;
transferring the file to at least one agent responsible for managing at least one of the devices; and
instructing the at least one agent to update the software module in the plurality of devices.

2. The method of claim 1, wherein the data header includes a password to be used in authenticating a user who generated the request to update the software module, and authenticating the request comprises validating the password entered by the user.

3. The method of claim 1, wherein the data header includes information identifying types of devices compatible with a software module, the devices authenticate the user identified in the request.

4. The method of claim 1, wherein the data header includes logic instructions, executable on a processor, for loading a software module into the memory of a device.

5. The method of claim 4, wherein the logic instructions in the data header are executed by the agent.

6. The method of claim 1, wherein the data header includes an ECO field indicating engineering change order.

7. The method of claim 1, further comprising updating the software in the plurality of devices.

8. The method of claim 7, wherein software on a plurality of devices is updated in parallel.

9. The method of claim 7, wherein the agent executes a segmented codeload where appropriate.

10. A system for downloading code to a plurality of devices in a storage network, comprising:
a command processor for receiving a command from an external source to download a software module to a plurality of devices matching a predefined set of criteria;
a storage medium for storing information about devices in the storage network and the topology of the storage network, the information including at least an identifier associated with the device and a path from the system to the device;
a device selector module for receiving a command from the command processor and selecting devices from the storage medium that satisfy the predefined criteria;
a coordinator module for distributing software modules and coordinating the distributed parallel code load process; and
a multivendor device download module for initiating the software download to the plurality of devices in the network.

11. The system of claim 10, further comprising a vendor-independent user interface that hides device-specific requirements from the user and that can be accessed from multiple clients.

12. The system of claim 10, further comprising a scheduling module that permits code loads to be scheduled.

13. The system of claim 10, wherein the system supports code load to multiple devices from multiple vendors.

14. The system of claim 10, wherein the system implements a contemporaneous parallel code download to multiple devices.

15. The system of claim 10, further comprising a module for computing a path for code download.

16. The system of claim 10, wherein the system implements path-based distributed code download.

17. The system of claim 10, wherein the system implements load-based distributed code download.

18. The system of claim 10, wherein the system generates an event log of the code load status.

19. The system of claim 10, further comprising a notification handler capable of notifying a user of the status of code loads.

20. The system of claim 10, further comprising a device discovery module that implements multifaceted conglomerate methods of device discovery.

21. The system of claim 10 further comprising a host agent module located in a separate host computer, wherein the host agent module comprises a host-independent host agent layer and a host-dependent host agent layer.
